(19) United States
(12) Patent Application Publication
(10) Pub. No.: US 2024/0003791 A1
(43) Pub. Date: Jan. 4, 2024

(54) PORTABLE SURFACE NANODROPLET-BASED EXTRACTION DEVICE FOR HIGHLY SENSITIVE CHEMICAL ANALYSIS

(71) Applicant: Universiteit Twente, Enschede (NL)

(72) Inventors: Xuehua ZHANG, Enschede (NL); Detlef LOHSE, Enschede (NL)

(21) Appl. No.: 18/258,144

(22) PCT Filed: Dec. 17, 2021
(86) PCT No.: PCT/NL2021/050774

§ 371 Date: Jun. 16, 2023

(30) Foreign Application Priority Data
Dec. 18, 2020 (NL) 2027157

(51) Int. Cl. G01N 1/40

(52) U.S. Cl. CPC G01N 1/4055; G01N 2001/4061

(57) ABSTRACT

A method and system for concentrating an analyte (A). Liquid droplets (D) of an extractant liquid (Le) are adhered to a wall (10w) of a container, e.g. capillary tube. A sample fluid (Fs) comprising the analyte (A) is provided in the container (10) to contact the liquid droplets (D). The analyte (A) has a higher solubility in the liquid droplets (D) than in the sample fluid (Fs). This causes the analyte (A) to be extracted from the sample fluid (Fs) and concentrated in the liquid droplets (D). After extraction, the liquid droplets (D) are collected, e.g. scraped, from the wall (10w) for obtaining the concentrated analyte (A). A concentrated liquid (La) can be formed by collecting the liquid droplets (D) from the wall (10w). The analyte (A) can be measured in the concentrated liquid (La) using any suitable measurement technique.

### TECHNICAL FIELD AND BACKGROUND

The present disclosure relates to methods and systems for concentrating an analyte.

Concentrating or pre-concentrating of analytes can be used, e.g., for improving sensitivity of analysis. For instance, detecting micropollutants such as pesticides from environmental water can benefit from a sample preparation method to concentrate the analyte into a smaller volume. Dispersive liquid-liquid microextraction (DLLME) is a method which can be based on spontaneous emulsification upon mixing of a water-insoluble extractant, a dispersive solvent and the sample aqueous solution to yield fine droplets of the extractant. A hydrophobic compound can be extracted rapidly into the droplets of extractant, e.g. oil, because of its higher solubility in the extractant than in water. When the analyte is extracted and concentrated in the droplets, the droplets can be collected via a centrifuge. Although DLLME can offer reliable analyte preconcentration, typically a large sample volume is needed and, in principle, only extractants that are denser than the sample can be centrifuged and collected.

Li, M., Dyett, B., Yu, H., Bansal, V., Zhang, X. H., Small 2019, 15, 1804683 [DOI: 10.1002/smll.201804683] describe a femtoliter surface droplet-based platform for direct quantification of trace of hydrophobic compounds in aqueous solutions. Formation and functionalization of femtoliter droplets, concentrating the analyte in the solution are integrated into a simple fluidic chamber, taking advantage of the long-term stability, large surface-to-volume ratio and tunable chemical composition of these droplets. In-situ quantification of the extracted analytes is achieved by surface-enhanced Raman scattering (SERS) spectroscopy by nanoparticles on the functionalized droplets.

Li, M., Dyett, B., Zhang, X. H, Anal. Chem. 2019, 91, 10371-10375 [DOI: 10.1021/acs.analchem.9b02586] describe femtoliter droplet-based determination of oil-water partition coefficient. The procedure is automated by continuous solvent exchange, and the analyte partition in the droplets is quantified from the in situ UV-vis spectrum collected by a microspectrophotometer. These oil droplets are located on a solid surface in contact with an immiscible aqueous medium, which does not require an additional step for separation or collection of droplets from the bulk liquid mixture and allows for online detection of the extracted compounds.

Unfortunately, known DLLME techniques may not be suitable for all types of samples. Furthermore, the available techniques for surface based analysis may be limited. So there is a need for improved methods and devices that allow for the analysis of a wide variety of samples and/or the use of different analysis techniques.

### SUMMARY

To provide new applications and alleviate problems associated with known methods, the inventors have developed a simple and reliable method for analyte preconcentration by leveraging surface nanodroplets formed on a container wall. In particular, the inside wall of a glass capillary tube can be used to reliably form suitable droplets, e.g. by a solvent exchange process. For example, sample solution can be injected through the capillary to extract the analytes into the droplets formed on the wall. Advantageously, the droplets with the concentrated analyte can be collected afterwards, so they can be analyzed by any conventional analytical equipment.

Up to now, nano-extraction has not been applied in analyte concentrating from slurries, e.g. high-solid suspensions without pre-removal of the solids. For example, the use of centrifuge based separation is typically unsuitable for samples which also contain solid contents; and it could be expected that the stability and/or efficiency of surface based droplets are affected by the solid content. So it has hitherto remained unclear how the solids affect the droplet stability and extraction efficiency and rate. Nevertheless, the inventors demonstrate in embodiments of the present disclosure that there can be an advantageous application of surface nanodroplets to extract and detect compounds also from high-solid suspensions. Through in-situ detection of a model compound from suspension samples, the inventors surprisingly find that final extraction outcome by surface nanodroplets is not influenced by the solid concentration, although the particles may slow down initially due to their adsorption at the droplet interface. As proof-of-concept, the inventors demonstrate extraction and detection of target analyte from industrial waste slurry. As will be appreciated, the present approach can facilitate and speed up the pre-treatment of suspension samples by enabling a one-step extraction of target analytes. This novel method may, e.g., be applicable to extraction and analysis of high-solid suspensions in various fields such as water quality monitoring, food quality control, or drug analysis from blood.

### BRIEF DESCRIPTION OF DRAWINGS

These and other features, aspects, and advantages of the apparatus, systems and methods of the present disclosure will become better understood from the following description, appended claims, and accompanying drawing wherein:

FIG. 1A illustrates a method for concentrating an analyte;

FIG. 1B illustrates liquid droplets adhered to an inside wall of a fluid duct;

FIGS. 2A-2C illustrate forming liquid droplets on a wall;

FIGS. 3A-3C illustrates concentrating an analyte from a sample fluid in liquid droplets on a wall;

FIGS. 4A-4C illustrate collecting liquid droplets with concentrated analyte from a wall;

FIG. 5 illustrates a schematic diagram of surface nanodroplet formation and analyte detection using a portable solvent exchange device;

FIG. 6 illustrates steps for operating a portable nano-extraction device for nanodroplet forming and extraction;

FIG. 7 illustrates influence of exposure time on background Nile red fluorescence intensity;

FIG. 8 illustrates effect of flow rate, oil concentration and oil type on the formation of surface nanodroplets;

FIG. 9 illustrates extraction of Nile red dye from samples with various particle concentrations;

FIG. 10 illustrates influence of solid particle an extraction time;

FIG. 11 illustrates limit of detection and low sample volume requirement of a portable nano-extraction device;

FIG. 12 illustrates limit of detection for Rhodamine B dye;

FIG. 13 illustrates a plot showing the relationship between the intensity of the droplet with the total surface area offered by the particles;

FIG. 14 illustrates processing of a sample at low volume;

FIG. 15 illustrates extraction of analyte from complex oil sand wastewater sample;

FIGS. 16A-D illustrates various geometries for adhering droplets;

FIG. 17A illustrates automated mixing of extractant solutions for multi-component droplet formation;

FIG. 17B illustrates a flow cell for adhering droplets inside.

### DESCRIPTION OF EMBODIMENTS

Terminology used for describing particular embodiments is not intended to be limiting of the invention. As used herein, the singular forms “a”, “an” and “the” are intended to include the plural forms as well, unless the context clearly indicates otherwise. The term “and/or” includes any and all combinations of one or more of the associated listed items. It will be understood that the terms “comprises” and/or “comprising” specify the presence of stated features but do not preclude the presence or addition of one or more other features. It will be further understood that when a particular step of a method is referred to as subsequent to another step, it can directly follow said other step or one or more intermediate steps may be carried out before carrying out the particular step, unless specified otherwise. Likewise it will be understood that when a connection between structures or components is described, this connection may be established directly or through intermediate structures or components unless specified otherwise.

The invention is described more fully hereinafter with reference to the accompanying drawings, in which embodiments of the invention are shown. In the drawings, the absolute and relative sizes of systems, components, layers, and regions may be exaggerated for clarity. Embodiments may be described with reference to schematic and/or cross-section illustrations of possibly idealized embodiments and intermediate structures of the invention. In the description and drawings, like numbers refer to like elements throughout. Relative terms as well as derivatives thereof should be construed to refer to the orientation as then described or as shown in the drawing under discussion. These relative terms are for convenience of description and do not require that the system be constructed or operated in a particular orientation unless stated otherwise.

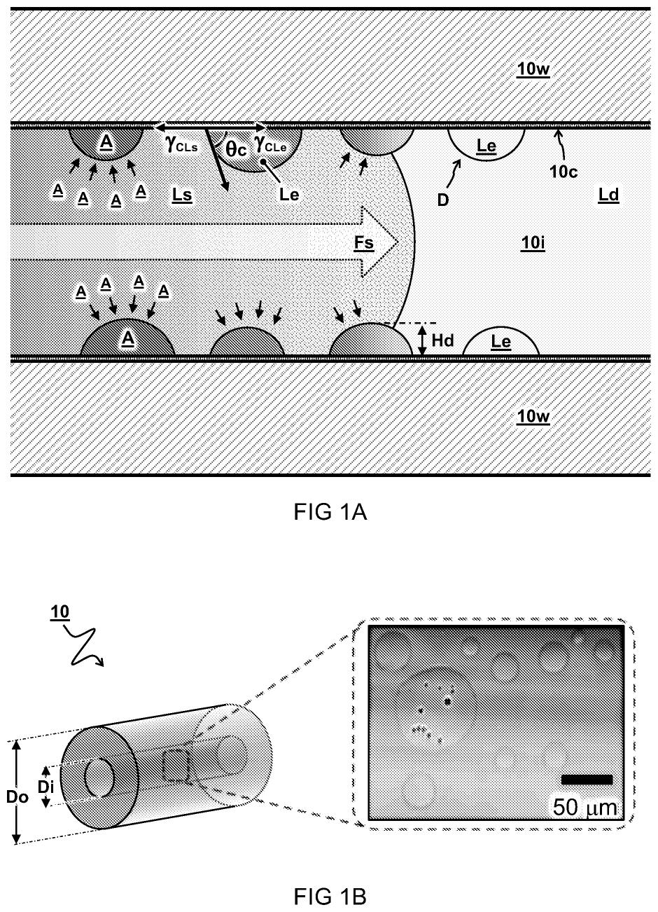

FIG. 1A illustrates a method for concentrating an analyte “A”. In some embodiments, an extractant liquid “Le” is provided. In one embodiment, the liquid droplets “D” of the extractant liquid “Le” are adhered to a wall 10w. For example, the wall can be part of a container 10 capable of holding a fluid and/or liquid, and or passing the fluid and/or liquid there through. Preferably, the wall 10w is an inner wall of a flow channel.

In one embodiment, e.g. as shown, a sample fluid “Fs” is provided comprising at least one analyte “A”. Preferably, the sample fluid “Fs” is provided in the container 10 to contact the liquid droplets “D”. Most preferably, the analyte “A” has a higher solubility in the liquid droplets “D” than in the sample fluid “Fs”. This may cause the analyte “A” to be extracted from the sample fluid “Fs” and concentrated in the liquid droplets “D”. Advantageously, the concentrated analyte “A” can be obtained by collecting the liquid droplets “D” from the wall 10w. Preferably, the sample fluid “Fs” is removed from the container 10 prior to collecting the liquid droplets “D” from the wall 10w, as described in further detail below.

In some embodiments, the liquid droplets “D” comprise, or are essentially formed of an extractant liquid “Le” which is essentially immiscible in the sample fluid “Fs”. In other or further embodiments, the sample fluid “Fs” comprises, or is essentially formed of a sample liquid “Ls” dissolving or otherwise carrying the analyte “A”. Typically, the analyte “A” is at least partially dissolved in the sample liquid “Ls” and/or the sample liquid “Ls” is at least capable of carrying the analyte “A”. For example, sample liquid “Ls” is capable of dissolving the analyte “A” e.g. up to a relatively low concentration, while the extractant liquid “Le” is capable of dissolving the analyte “A” in a relatively high concentration. In other words, the analyte “A” has a higher solubility in the extractant liquid “Le” than in the sample liquid “Ls”, e.g. by at least a factor two, five, ten, twenty, fifty, hundred, or more. Alternatively, or in addition to a liquid, the sample fluid “Fs” can in principle also be supplied to the container 10 in the form of a gas comprising or otherwise carrying the analyte “A” in contact with the liquid droplets “D”.

In some embodiments, the present methods are used for concentrating an analyte “A” from a slurry. e.g. without pre-removal of the solid contents. In one embodiment, the sample fluid “Fs” and/or sample liquid “Ls” comprises, or is essentially formed by, a slurry having a solid content of at least 5 wt %, at least 10 wt %, at least 20 wt %, e.g. up to 30 wt %, or more. For example, the sample fluid “Fs” comprises an aqueous and/or oil based slurry, which may include solid particles such as sand or other solid contents. Also other sample fluids can be used.

In some embodiments, the extractant liquid “Le” and sample liquid “Ls” are essentially immiscible. In other words, the liquid droplets “D” of the extractant liquid “Le” (essentially) do not mix with the sample liquid “Ls”. For example, miscibility is understood as the property of two substances to mix, e.g. ranging between fully miscible (able to fully dissolve in each other at any concentration) and immiscible (proportion in which the mixture does not form a solution). In a preferred embodiment, a proportion in which the extractant liquid “Le” mixes with the sample liquid “Ls” to form a (clear) solution is less than one percent, less than a tenth of a percent, less than a hundredth of a percent, or even much less, e.g. essentially no mixing.

In some embodiments, the extractant liquid “Le” comprises, or is essentially formed by an apolar solvent. In one embodiment, the extractant liquid “Le” comprises an oil such as octanol. In another or further embodiment, the extractant liquid “Le” comprises a monomer such as 1,6-Hexanediol diacrylate. In another or further embodiment, the extractant liquid “Le” comprises an aromatic solvent such as toluene. In another or further embodiment, the extractant liquid “Le” comprises an alkane such as decane. Also other extractants can be envisaged as the extractant liquid “Le”. For example, more unconventional liquids may include (extremely viscous) silicone elastomers or ionic liquids to form droplets. Also mixes of various solvents can be used to form the extractant liquid “Le”. It will be appreciated that the formation of droplets with various extractant liquids expands the type of chemicals that can be extracted and analyzed, as extraction of certain analytes can depend on the extractant type. Moreover, a wide library of extractant liquids can help to avoid the use of toxic and harmful extractants.

In some embodiments, the sample liquid “Ls” comprises, or is essentially formed by a polar solvent. In one embodiment, the sample liquid “Ls” comprises an aqueous solution, e.g. a solvent such as water. A qualitative way of distinguishing between “polar” and “non-polar” liquids is miscibility with water. Quantitatively, the polarity can be measured using the “dielectric constant” or permittivity. The greater the dielectric constant, the greater the polarity. For example, a solvent can be considered apolar having a dielectric constant less than five or less than ten Another or further measure can be the dipole moment. For example, a solvent can be considered polar having a dielectric constant more than ten and/or a dipole moment more than two debye (>2.0 D).

In some embodiments, the wall 10w of the container comprises a coating 10c or is otherwise treated to promote adhesion, at least of the liquid droplets “D” and/or extractant liquid “Le”. For example, the wall 10w is treated to provide a hydrophobic and/or lipophilic surface which can promote adhesion of apolar liquid droplets (e.g. the extractant liquid “Le”) and/or repel adhesion of an aqueous solution (e.g. the sample liquid “Ls”). Also other or further types of coating and/or treatments can be used dependent on a composition of the liquid droplets “D” and/or sample fluid “Fs”. For example, it can also be envisaged to extract polar compounds from an apolar medium, e.g. by providing a hydrophilic wall and/or coating. Alternatively, or in addition, to coating the wall, adhesion can be promoted or prevented, e.g. dependent on a surface roughness of the wall.

In some embodiments, the liquid droplets “D” are formed by an extractant liquid “Le” having a first adhesiveness γ_{CL1} to a coating 10c of the wall 10w, wherein the sample fluid “Fs” is formed by a sample liquid “Ls” (with the analyte “A”) having a second adhesiveness γ_{CL2} to the wall 10w, wherein the first adhesiveness γ_{CL1} is higher than the second adhesiveness γ_{CL2}. For example, the adhesiveness can be quantified by a respective interfacial tension or energy γ_{CL1} and γ_{CL2} between the extractant liquid “Le” and the wall, and between the sample liquid “Ls” and the wall, respectively. In one embodiment, the interfacial tension γ_{CL1} between the extractant liquid “Le” and the wall 10w is higher than the γ_{CL2} between the sample liquid “Ls” and the wall 10w, e.g. by at least ten percent (factor 1.1), twenty percent (factor 1.2), fifty percent (factor 1.5), or much more, e.g. at least a factor two, three, five, ten, or more.

In other or further embodiments, the contact angle θc of a liquid droplet on the wall 10w and/or coating 10c can be used to quantify or compare adhesiveness, i.e. affinity for that liquid to adhere to that wall. In general, the contact angle of a droplet against a solid (e.g. flat) surface is the angle (conventionally measured through the liquid of the droplet) where a liquid-vapor or liquid-liquid interface meets the solid surface. It can be used to quantify the ‘wettability’ of the solid surface by the liquid forming the droplets (e.g. compared to the surrounding fluid). For example, the equilibrium contact angle can be used to reflect a relative strength of the (first) liquid, solid, and vapour (or sample liquid) molecular interaction. For example, the contact angle of a droplet of the extractant liquid “Le” is preferably smaller than the contact angle of a droplet of the sample liquid “Ls”, e.g. by at least ten degrees (plane angle), at least twenty degrees, at least fifty degrees or more. For example, droplets of the extractant liquid “Le” (e.g. in surrounding air or in the surrounding sample liquid “Ls”) typically have a contact angle θc of less than ninety degrees (plane angle), less than seventy degrees, or even less than fifty degrees. For example, the droplets of the sample liquid “Ls” typically have a contact angle θc more than ninety degrees, more than hundred twenty degrees, or even more, e.g. being essentially repelled from the wall 10w. In some embodiments, the angle can be modelled and/or experimentally observed, e.g. at room temperature (20° C.)/standard pressure (1 bar)/in surrounding air or other medium.

In principle, the container 10 can be any container having one or more (inside) walls configured to adhere the liquid droplets “D” and (at least momentarily) allow the sample fluid “Fs” with the analyte “A” to contact the liquid droplets “D”. For example, the sample fluid “Fs” can be poured into an open container. In a preferred embodiment, wherein the container 10 is formed by a flow channel, and the liquid droplets “D” are adhered to the wall 10w of the flow channel. Most preferably, the flow channel is closed, e.g. forming a duct.

FIG. 1B illustrates liquid droplets “D” adhered to an inside wall 10w of a fluid duct. In some embodiments, the liquid droplets “D” are adhered to an inside wall 10w of a fluid duct forming the container 10, wherein a flow of the sample fluid “Fs” is provided through the fluid duct passing in contact with the liquid droplets “D” which (predominantly) stay adhered to the wall 10w. Most preferably, the wall(s) of the flow channel are provided with liquid droplets “D” around the whole circumference or perimeter. Preferably, a height “Hd” of the liquid droplets “D” from the wall is much smaller than the inner diameter “Di” of the tube, e.g. by a least a factor ten, twenty, fifty, hundred or more.

In some embodiments, the fluid duct has a length of at least one or two centimeters, preferably at least five centimeters, e.g. between ten and thirty centimeters. In principle, the longer the duct, e.g. tube, the more droplets can be adhered along a trajectory for the sample fluid “Fs”. For some applications, also shorter ducts can be used. In other or further embodiments, the container 10 is formed by a capillary tube having an inner diameter less than three millimeter, preferably less than two millimeter, e.g. between 0.5-1.5 millimeter, or even less than one millimeter. In principle, the lower the diameter of the tube, the higher the effective surface to volume ratio. On the other hand, a certain minimum diameter can be beneficial depending on the method of collecting the droplets and/or depending on the sample fluid “Fs”, e.g. slurry. Typically, the liquid droplets “D” as described herein are surface microdroplets or nanodroplets, e.g. having a (median or average) diameter and/or height less than hundred micrometer, less than ten micrometer, or even less than one micrometer. Most preferably, the liquid droplets “D” are surface nanodroplets having a (median or average) height less than hundred nanometer and/or a (median or average) volume less than ten femtoliter (10⁻¹⁵ L), preferably less than one femtoliter.

As will be appreciated, the current methods and systems, allow extracting and analyzing from even very small quantities of sample liquid “Ls”. In some embodiments, the analyte “A” is concentrated from a sample liquid “Ls” having a total volume of less than ten milliliter, less than one milliliter, less than hundred microliter, or even less than ten microliter. For example, a sample liquid “Ls” can be provided in a capillary tube which comprises (preferably exclusively) the liquid droplets “D” on its inner wall. Accordingly, a small quantity of the sample liquid “Ls” can be easily ‘sucked’ into the tube by capillary forces to start the concentration process.

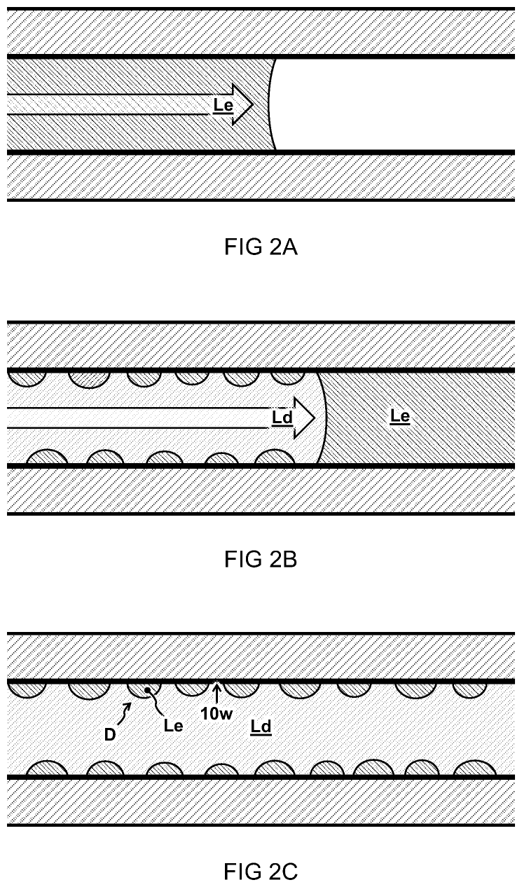

FIGS. 2A-2C illustrate forming liquid droplets “D” on a container wall 10w. In some embodiments, the container 10 is provided with liquid droplets “D” adhered to the wall 10w by providing an extractant liquid “Le” in the container 10, wherein the extractant liquid “Le” has a first adhesiveness to the wall 10w. Other or further embodiments comprise providing a displacement liquid Ld in the container 10 to (mostly) displace or otherwise remove the extractant liquid “Le” from the container 10 (except the droplets sticking to the wall 10w). For example, the sample liquid has a second adhesiveness to the wall 10w which is lower than the first affinity. Preferably, the extractant liquid “Le” and displacement liquid Ld are essentially immiscible. In one embodiment, e.g. as shown, the displacement of the extractant liquid “Le” by the displacement liquid Ld results in the liquid droplets “D” of the extractant liquid “Le” remaining adhered to the wall 10w.

Preferably, as described herein, the container 10 comprises or is formed by a fluid and/or liquid duct. Accordingly, the extractant liquid “Le” and displacement liquid Ld can be respectively flowed through the duct, e.g. subsequently. Alternatively, the liquids are respectively supplied and removed from any other type of container. In some embodiments (not shown), prior to providing an extractant liquid “Le” in the container 10, the wall 10w of the container is treated to promote adhesion of the extractant liquid “Le”. For example, the wall is thoroughly cleaned and/or immersed in a hydrophobic solution that binds with the wall 10w to form a coating 10c.

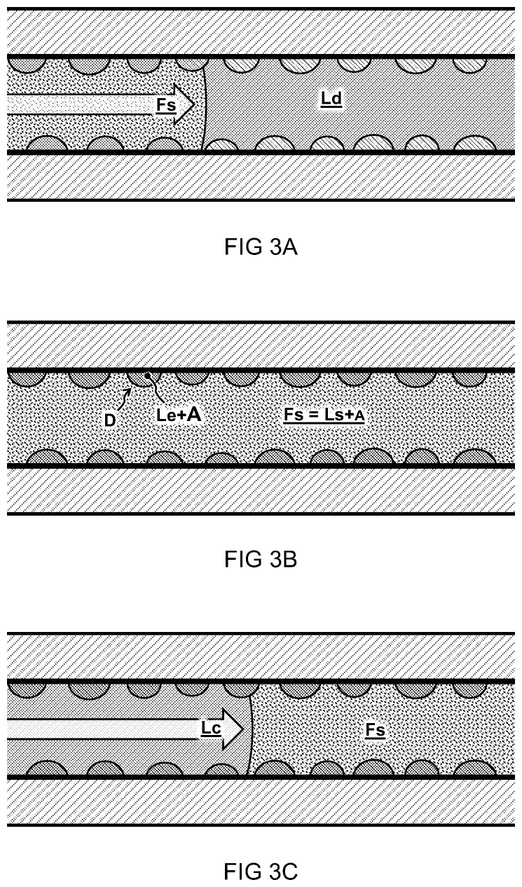

FIGS. 3A-3C illustrates concentrating an analyte “A” from a sample fluid “Fs” in liquid droplets “D” on a wall 10w. In some embodiments, the sample fluid “Fs” is provided in the container 10 to contact the liquid droplets “D” by flowing a sample liquid “Ls” (dissolving or otherwise carrying the analyte “A”) through the container 10 while the liquid droplets “D” stay adhered to the wall 10w. For example, the displacement liquid Ld is displaced by a flow of the sample liquid “Ls”. In one embodiment, the displacement liquid Ld is formed by a similar or the same liquid as forming the sample liquid “Ls”, but e.g. without the analyte “A”. For example, the sample liquid “Ls” and displacement liquid Ld are both polar liquids. For example, the sample liquid “Ls” comprises an aqueous solution with analyte “A” and while the displacement liquid Ld comprises (pure) water. It can also be envisaged to directly provide the sample fluid “Fs” and/or sample liquid “Ls” (with the analyte “A”) acting as the displacement liquid Ld. The displacement liquid Ld can also be an entirely different liquid, e.g. selected to promote droplet formation.

In some embodiments, after providing the sample fluid “Fs” in the container 10, and before collecting the liquid droplets “D”, the sample fluid “Fs” is removed, e.g. flushed, from the container 10 by (a flow of) a cleaning liquid “Lc”. Preferably, the cleaning liquid “Lc” has relatively low solubility for the analyte “A”, so the cleaning liquid “Lc” does not substantially dilute and/or extract the analyte “A” from the liquid droplets “D”. In one embodiment, the cleaning liquid “Lc” is a similar or the same liquid as the displacement liquid Ld and/or sample liquid “Ls”. For example, the cleaning liquid “Lc” comprises a polar solvent such as water. In another or further embodiment, the cleaning liquid “Lc” is selected to be easily evaporated, which can aid in the subsequent removal of the cleaning liquid “Lc”, as discussed with reference to the next figures.

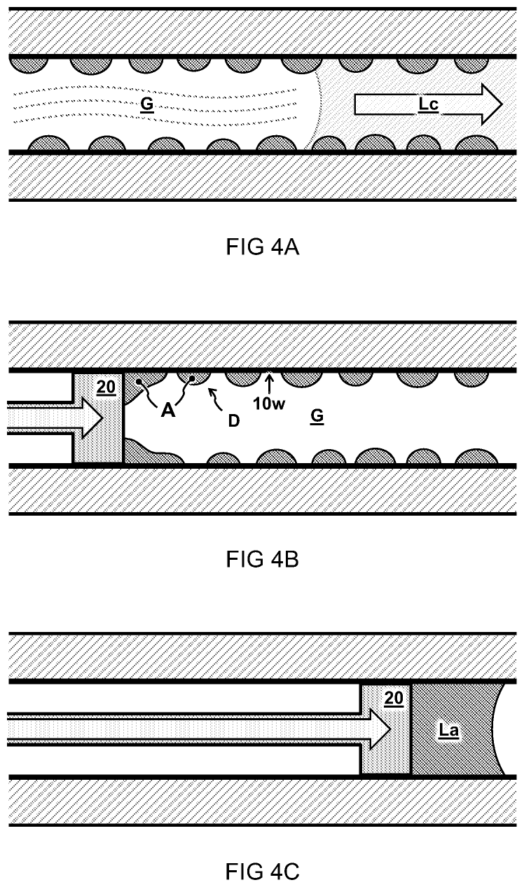

FIGS. 4A-4C illustrate collecting liquid droplets “D” with concentrated analyte “A” from a wall 10w. In some embodiments, the cleaning liquid “Lc” and/or sample liquid “Ls” is removed by flushing a drying gas “G”, e.g. air or (dry) nitrogen, through the container 10, e.g. fluid duct, while the liquid droplets “D” with the concentrated analyte “A” remain adhered to the wall 10w. Advantageously, by removing the excess liquid before collecting the droplets, the concentration of analyte “A” can be maintained, e.g. as opposed to re-dissolving the analyte “A” in another liquid. Optionally, the drying gas “G” can be heated to further improve drying properties. Also other or further methods of removing the cleaning liquid “Lc” and/or sample liquid “Ls” can be envisaged such as simply heating the container 10/tube, centrifuging, et cetera.μL

In some embodiments (not shown), a concentration of the analyte “A” is quantified, e.g. by measuring a spectrum of the liquid droplets “D”. For example, a surface-sensitive optical techniques, such as reflection mode FTIR (Fourier Transform Infrared Spectroscopy) can be used. More preferably, the droplets are rinsed off from the inner wall surface and, e.g., injected into an analytic. This enables, in principle, the use of any desired analysis technique. Most preferably, e.g. as shown in FIGS. 4B and 4C, the liquid droplets “D” are removed from the wall 10w and combined to form a concentrated liquid “La”, e.g. in a second container (not shown). Other or further embodiments (not shown) comprise comprising measuring the analyte “A” in the concentrated liquid “La”. For example, the concentrated liquid is provided to a measurement system or analytic instrument. In principle, the concentrated liquid can be analyzed using any suitable technique for measuring one or more analytes in the concentrated liquid.

In one embodiment, the concentrated liquid is analyzed using (microphoto)spectroscopic techniques, e.g. by an taking ultraviolet, visible and/or infrared spectrum. In another or further embodiment, the concentrated liquid is analyzed using chromatography, e.g. high performance liquid chromatography (HPLC), gas chromatography (GC), mass spectrometry (MS), et cetera. Also other known or yet to be discovered techniques can be used. It can also be envisaged to further process the concentrated liquid before or after analysis. It can also be envisaged to further concentrate and/or isolate the analyte from the concentrated liquid. Alternatively, or in addition to analysis, the concentrated and/or isolated analyte “A” can also be used for other purposes, e.g. as part of producing a chemical compound with the analyte “A”.

In a preferred embodiment, the liquid droplets “D” are collected by mechanically scraping the liquid droplets “D” from the wall 10w. In other words, the liquid droplets “D” can be collected from the wall 10w by a tool 20 which is configured to physically contact and move along the one or more inside walls of the container. In one embodiment, the liquid droplets “D” are adhered to an inside wall 10w of a fluid duct forming at least part of the container 10, and the liquid droplets “D” are collected from the inside wall 10w by pushing (or pulling) a tool 20 through the fluid duct. For example, the tool is formed by a plunger with an outer diameter corresponding to an inner diameter of a tube-like container. In another or further embodiment, the tool comprises a resilient material which can improve a fit or connection to the inside wall. Also scraping off a flat container wall can be envisaged.

Although the inventors find that mechanical scraping, e.g. by a plunger, provides an easy and effective solution for collecting droplets strongly adhered to a wall, also other or further methods can be envisaged. For example, the droplets can be collected by (forcefully) blowing a gas, such as air, through the container, e.g. tube, while collecting the droplets on the other end. Advantageously, the gas need not affect the concentrated droplets. Alternatively, or additionally, it can also be envisaged that the droplets are collected from the container by centrifuging. For example, the (capillary) tube can be centrifuged to force the droplets out one side. Alternatively, or additionally, the container could even be disintegrated, e.g. afterwards filtering solid parts of the disintegrated container from the concentrated analyte.

Aspects of the present disclosure can also be embodied as a system for performing operational acts in accordance with the present teachings, e.g. concentrating an analyte “A”. In some embodiments, the system comprises or couples to a capillary tube having an inner wall 10w. In other or further embodiments, the system comprises a flow controller e.g. connectable to the capillary tube and/or respective supply chambers to provide the respective liquids/fluids. For example, the flow controller is configured/programmed to provide a sequence of different flows through the tube or other container in accordance with the present teachings. In other or further embodiments, the system comprises or couples to a (mechanical) tool 20. For example, the tool is configured to (automatically) collect the liquid droplets “D” from the inner wall 10w for obtaining the concentrated analyte “A”. In other or further embodiments, the system comprises an analyzer configured to receive a concentrated liquid “La” formed of the collected liquid droplets “D” with the concentrated analyte “A”, wherein the analyzer is configured to determine, e.g. measure, a presence and/or quantity of the analyte “A”. For example, a quantity of the analyte “A” can be related to a concentration of the analyte “A” in the original sample liquid “Ls”, by calibration or in any other way. In one embodiment, the system is embodied as a lab-on-chip. Aspects of the present disclosure can also be embodied as a kit for use in the system and/or in applying the method

In some embodiments, the system comprises or couples to a supply of extractant liquid “Le” (configured to be) coupled with the capillary tube and configured to provide a flow of the extractant liquid “Le” through the capillary tube. For example, the extractant liquid “Le” has a first adhesiveness γ_{CL1} to form liquid droplets “D” of the extractant liquid “Le” adhered to the inner wall 10w. In other or further embodiments, the system comprises or couples to a supply of sample liquid “Ls” (configured to be) coupled with the capillary tube and configured to provide a flow of the sample liquid “Ls” with the analyte “A” through the capillary tube to contact the liquid droplets “D”. Preferably, the analyte “A” has a higher solubility in the liquid droplets “D” than in the sample liquid “Ls” causing the analyte “A” to be extracted from the sample liquid “Ls” and concentrated in the liquid droplets “D”. In other or further embodiments, the system comprises a supply of cleaning liquid “Lc” (configured to be) coupled with the capillary tube and configured to provide a flow of the cleaning liquid “Lc” through the capillary tube for removing the sample liquid “Ls”. In other or further embodiments, the system comprises a dryer and/or centrifuge coupled to the capillary tube, e.g. configured to remove the sample liquid “Ls” and/or cleaning liquid “Lc” prior to the tool 20 automatically collecting the liquid droplets “D”.

### EXPERIMENTAL

In the following, the inventors provide a detailed description of various experiments to illustrate possible applications and results of the invention. It will be understood that the general teachings of the invention are not limited only to these specific examples but can include other embodiments as described herein.

### Hydrophobization of Glass Capillary for Nanodroplet Formation

The surface of glass capillary tubes (Kimble Products, Inc., USA) with an inner diameter of 1.1, 1.4 mm, outer diameter of 1.5, 1.8 mm, and length of 100 mm was rendered hydrophobic using octadecyltrichlorosilane (OTS) (Sigma Aldrich). In brief, the glass capillary was cleaned with piranha solution made of 70% H₂SO₄ (Fisher Scientific) and 30% H₂O₂ (Fisher Scientific) (v/v) for 15 min at 75° C. After cleaning, the capillary tubes were sonicated in water and then in ethanol for 5 min each before drying by a stream of air. Subsequently, the capillary tubes were immersed into an amber bottle containing 100 mL of hexane (Sigma Aldrich) and 100 μL of OTS. The bottle was tightly closed and kept at room temperature (20.5° C.) for 12 hr. The OTS-treated glass capillaries were then cut to 50 mm in length. Then, the OTS-coated glass capillaries where sonicated in ethanol and in water for 10 min each to remove un-reacted OTS from the surface.

### Formation of Surface Nanodroplets

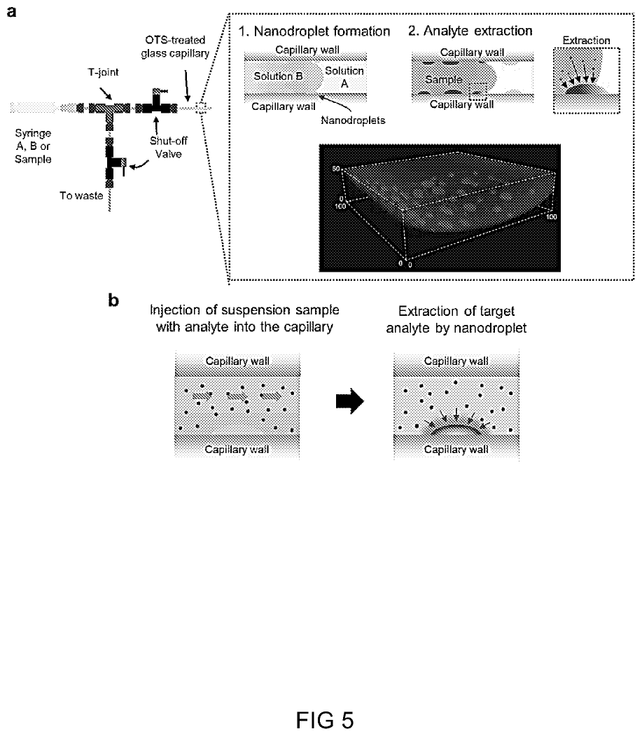

FIG. 5 illustrates a schematic diagram showing an example of surface nanodroplet formation and analyte detection using a portable solvent exchange device. a) The surface nanodroplets are formed an the inner wall of OTS-treated glass capillary tube. For detection, the analyte-containing sample can be injected into the capillary tube decorated with surface nanodroplets, into which analytes become extracted. Inset: confocal micrograph of surface nanodroplets formed an the inner wall of the glass capillary tube. b) Schematic showing extraction of analytes from suspension samples. Extraction is simply achieved by flowing the sample through the capillary tube. As the slurry flows through the capillary tube, analytes are readily extracted into the surface nanodroplets. Surface nanodroplets were formed inside the OTS-treated glass capillary tube using the solvent exchange process. To deliver the solutions, the capillary tube was connected to a portable device composed of two shut-off valves joined by a T-junction (FIG. 5-a). The shut-off valves could prevent trapping of air during the sequential delivery of solutions A and B, guaranteeing mixing between the two to drive oversaturation of extractant and form the nanodroplets an the capillary tube wall.

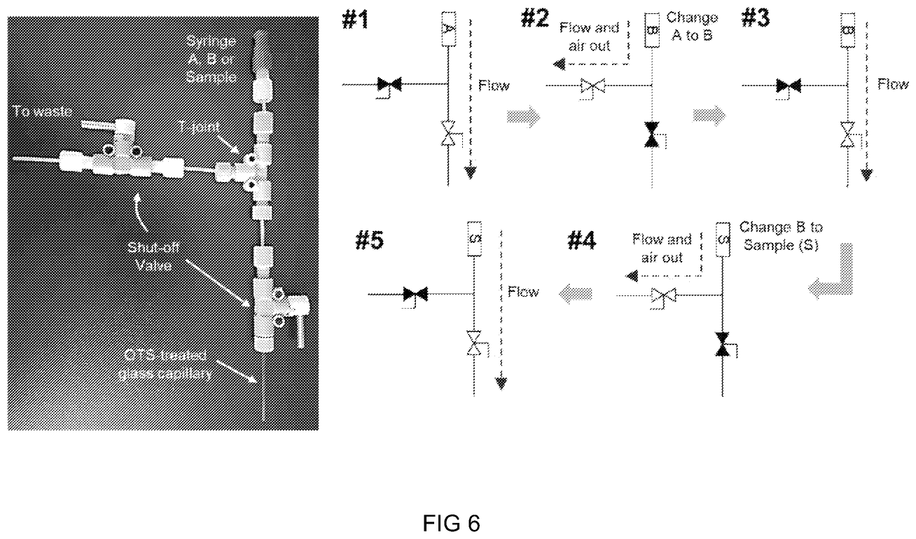

FIG. 6 illustrates steps for operating a portable nano-extraction device for nanodroplet forming and extraction. First, a solution of 5% octanol (Sigma Aldrich) in 50 vol % ethanol (Sigma Aldrich, reagent grade) aqueous solution (solution A) was injected into the glass capillary. At this point, only the outlet valve was open to let the solution flow to the capillary. Then the syringe was removed from the device and pure water (Solution B) was injected into the device using a new syringe. The air trapped during exchange of syringes could be removed by closing the outlet valve and opening the waste valve to block the passage of air to the capillary and flush it out to the side tube. After removing the air, the waste valve was again closed and outlet valve was opened to let water into the capillary to displace solution A and generate the droplets, as shown by the three-dimensional confocal fluorescent image in FIG. 5-a.

### Nano-Extraction of the Analyte Using Surface Nanodroplets

Target analytes were extracted from the solid suspension simply by injecting the suspension sample into the capillary tube with the nanodroplets on the wall. The solid particles in the suspension sample did not damage the nanodroplets “D” uring the extraction process due to pinning effect from the capillary tube wall. After extraction, the analytes in the droplet could be observed in-situ using fluorescence microscopy (FIG. 5-b). When the analyte concentration is too high and interferes with the detection, it is possible to remove the excess suspension sample in the capillary tube simply by washing it away with water. However, this was not always necessary within the range of concentrations tested in this work.

### Fluorescent Detection of Extracted Analytes

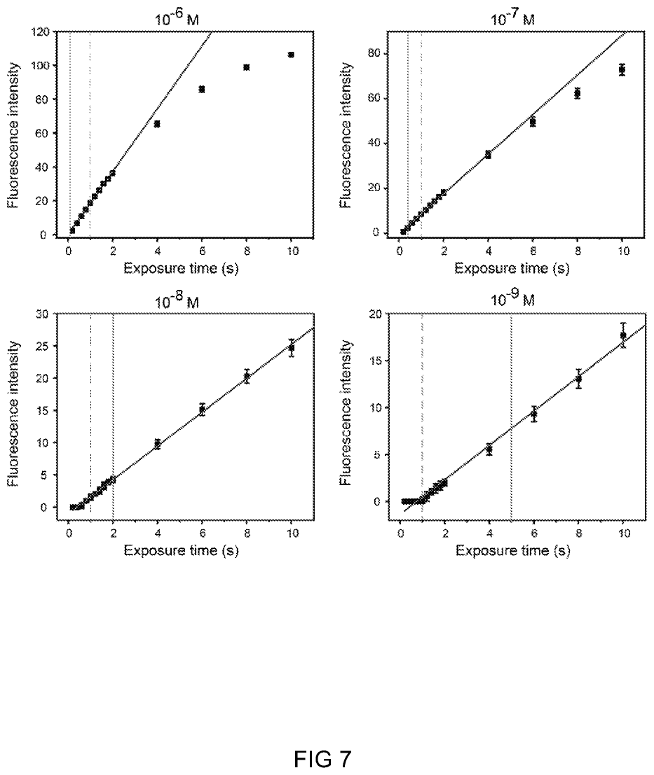

FIG. 7 illustrates influence of exposure time on background Nile red fluorescence intensity for 10⁻⁶ M to 10⁻⁹ M. The solid sloped line indicates the best fit line for linear region of fluorescence. The dashed vertical line represents the exposure time used for each experiment. The solid vertical line shows the exposure time to which the intensity data were normalized to (t=1 s).

For all fluorescence imaging, the capillary containing the droplets with extracted analytes were observed under green laser to excite both Rhodamine B and Nile red. Otherwise noted, the exposure times were kept constant. The intensity values of droplets were analyzed using ImageJ.

For the limit of detection tests, as the range of concentrations of analyte in the suspension sample is large (3 orders of magnitude), it was not possible to fix an exposure time to measure the fluorescence signals of droplets for all the cases. An exposure time set to detect the analyte concentration corresponding to 10⁻⁶ M was too skort to analyze droplets with lower concentrations such as 10⁻⁹ M. On the other hand, selecting an exposure time appropriate to detect an analyte concentration of 10⁻⁹ M was too long for a concentration of 10⁻⁶ M and resulted in intensity saturation. Therefore, in order to determine the limit of detection, the images were acquired at different exposure times, and the intensity values were normalized to the value corresponding to 400 ms of exposure time. To avoid erroneous normalization, fluorescent intensities of the background were obtained at various exposure times for different concentrations within the linear region.

Formation of Surface Nanodroplets on the Capillary Wall for Nano-Extraction from Solid Suspensions

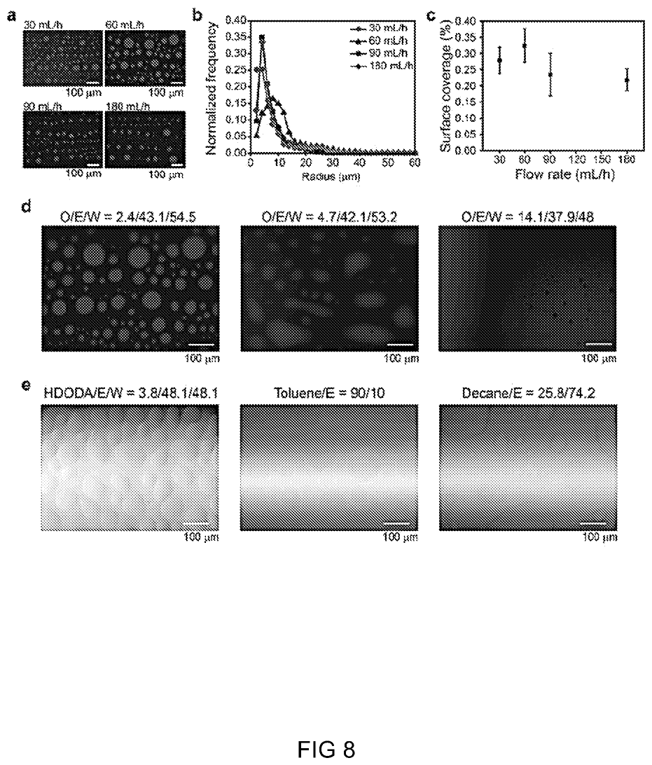

FIG. 8 illustrates effect of flow rate, oil concentration and oil type on the formation of surface nanodroplets in the glass capillary tube. a) Fluorescent images of droplets formed with flow rates of 30, 60, 90 and 180 mL/h for solution B. b) Size distribution of droplets formed at each flow rate condition. c) Surface coverage of droplets formed at each flow rate condition (mean±S.D.) d) Fluorescent images of droplets formed at different solution A compositions (in wt %). e) Optical microscope images of droplets formed using different types of oils. The compositions are in wt %.

First, we demonstrate how the injection flow rate and oil concentration influence the formation of surface nanodroplets on the capillary tube wall. Optical images FIG. 8-a show that the droplets are similar in size and surface coverage on the wall, independent of the flow rate from 30 to 180 mL/h. At the fastest flow rate, it took only ˜20 s to form the surface nanodroplets on a 50 mm-long tube due to the small diameter and volume of the tube. The probability distribution function (PDF) plots in FIG. 8-b show that most droplets are ˜5 μm in base radius. The surface coverage (FIG. 8-c) is between 20% and 35%, comparable to the value on a flat substrate with the same coating. The independence of the droplet size distribution on the flow rate can be attributed to the geometry confinement in a capillary tube, in contrast to faster droplet growth at a faster flow demonstrated in a flow chamber with a flat substrate. An effective way to vary the droplet size is simply changing the oil (here: octanol) concentration in solution A. FIG. 8-d shows the fluorescent images of droplets formed with octanol as extractant. The flow rate was kept at 60 mL/h for all cases. As the concentration of octanol in solution A varied from 2.4 wt % to 4.7 wt %, the average base radius of the droplets increases from 10.9 μm to 14.3 μm. At even higher concentration of 14.1 wt %, the droplets were too large, covering the field of view. Controlling the size can be important for achieving high extraction efficiency as the droplet volume can influence the extraction performance. Surface nanodroplets can also be formed using many other types of extractants such as 1,6-Hexanediol diacrylate (a type of monomer), toluene (aromatic solvent), and decane (alkane), as shown in the optical microscope images in FIG. 8-e. The selection of solution A and B in each case was guided by the solubility diagram of the extractant liquid, the good solvent, and poor solvent. Solvent exchange can also be applied for forming droplets of unconventional liquids such as extremely viscous silicone elastomers or ionic liquids. These droplets can be formed on capillary tubes as well since the principle of droplet nucleation and growth is the same regardless of chamber geometry.

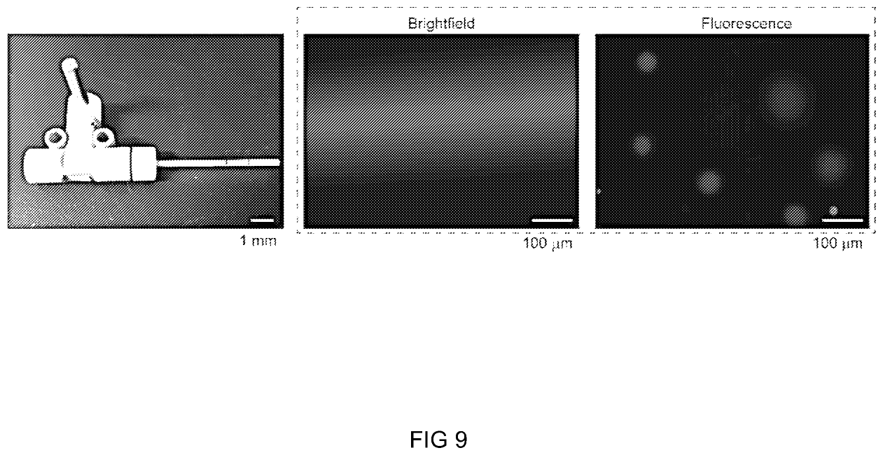

FIG. 9 illustrates extraction of Nile red dye from samples with various particle concentrations. Digital camera image of glass capillary filled with silica solution (left). Bright field (center) and fluorescent images of the capillary tube (right). The droplets are not visible in bright field but are clearly shown in the fluorescent image due to extraction of Nile red dye.

Here we demonstrate the capability of surface nanodroplets to extract analytes from solid suspensions. Nile red fluorescent dye at initial concentration of 10⁻⁶ M was used as a model compound. The dye was dissolved in suspensions containing 3.125 mg/mL to 12.5 mg/mL of 150 nm silica particles. This range of nanoparticles concentration is similar to the solid contents in sewage sludge (10 mg/leg˜1000 mg/kg). When the particle suspension was loaded into the capillary tube coated with preformed surface nanodroplets, it was difficult to observe the droplets in bright-field microscope images due to scattering of light by the particles (FIG. 9). However, in fluorescent images, the droplets were clearly visible as the model analyte was readily extracted from the suspension into the droplets. The strong fluorescence intensity in the droplets indicates successful extraction of the dye (the target analyte) by the surface nanodroplets even in the presence of solid particles. In the following sections, we show the influence of solid contents on the nano-extraction kinetics and detection sensitivity.

### Effect of Solid Contents on Nano-Extraction Kinetics

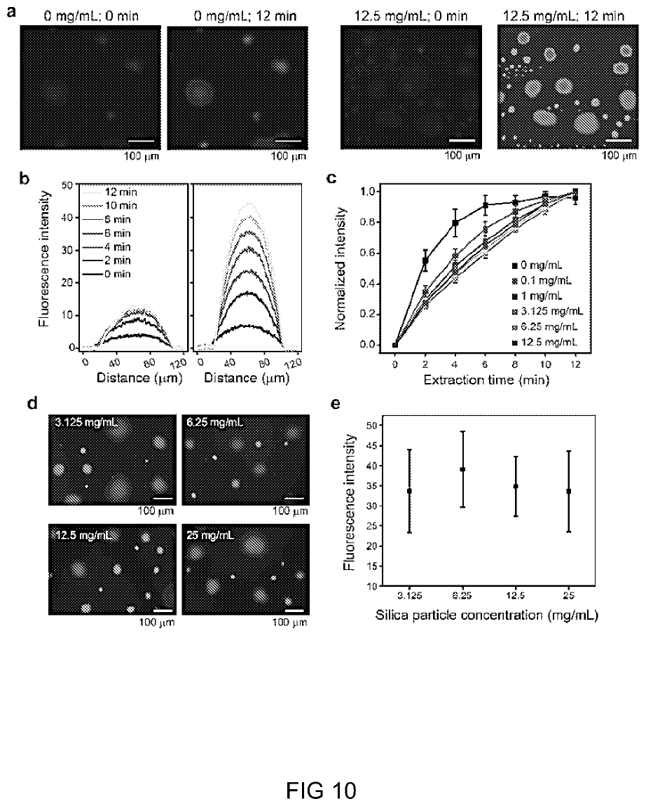

FIG. 10 illustrates influence of solid particle an extraction time. a) Fluorescent images of droplets extracting Nile red from sample with no particle (0 mg/mL) and with particle (12.5 mg/mL). b) Intensity profile across a droplet in samples with and without particle. c) Comparison of normalized maximum intensities of measured droplet over time. d) Fluorescence images and e) intensities of droplets after extracting Nile red from the slurry solutions with particle concentrations of 3.125, 6.25, 12.5, and 25 mg/mL, respectively. Here, the Nile red concentration was 10⁻⁶ M for all cases. Error bars represent ±S.D.

Here we compare the nano-extraction kinetics in water and in suspension sample. FIG. 10-a shows the fluorescent images of droplets extracting dye from an aqueous solution and from a silica suspension at concentration of 12.5 mg/mL. The images at 0 min were acquired as soon as the sample was injected into the capillary tube. FIG. 10-b shows the intensity profile across a single droplet tracked over 12 min. It is clear that for the aqueous solution (i.e. 0 mg/mL), the profiles overlap from ⁶Min whereas that for the silica solution does not reach its maximum value even after 12 min.

When the normalized maximum intensity across the droplet was plotted against time (FIG. 10-c), it was evident that the extraction time is delayed in the case of the suspension sample. The rate was distinguishable up to particle concentration of 0.1 mg/mL, but no difference was observed at higher concentrations from 1 mg/mL. The slower extraction time in the case of the suspension sample may be attributed to hindered transport of analytes into the droplet by adsorbed silica particles at the droplet-water interface. Similar results can be observed from liquid-liquid extraction using a single oil droplet rising up a column of particle solutions. While increased viscosity of a slurry can, in principle, also reduce mass transfer during extraction, this is unlikely the case since the silica concentration used here is not high enough to significantly influence the viscosity.

We can estimate the influence of solids on the extraction kinetics based, e.g. on the following expression modeling single drop microextraction:

$$\frac{{dC}_{drop}}{dt} = \frac{{A}_{int}}{{V}_{drop}} \overline{β} ( {pC}_{aq} - {C}_{drop} ) .$$

The concentration of the analyte extracted into the droplet (C_{drop}) is a function of time (t), concentration of analyte in the sample (Ca_{q}), partition coefficient (p), the ratio of free droplet interfacial area to droplet volume (Aᵢₙₜ/V_{drop}), and the mass transfer coefficient (β) relating the diffusivity and concentration boundary layer thickness around the droplet,

As the particles assemble on the droplet surface, the free droplet interfacial area (i.e. Aᵢₙₜ) decreases. With lower Aᵢₙₜ due to solid particle adsorption, the rate of increase of the analyte concentration in the droplet is slower. Assuming a surface coverage of 25%, it would require at least 3×109 particles to cover all the droplets, estimated using the size of individual particle (i.e. 150 nm). In a suspension with concentration of 0.1 mg/mL particles, there are 1.3×10⁹ particles available in the capillary, which is only ˜40% of particles required to cover all the droplets. However, at particle concentration of 1 mg/mL and above, the number of particles in the capillary is more than what is required for full droplet coverage (i.e., 1.2×10¹⁰ particles for 1 mg/mL case). This is significantly higher than the required particle number to fully cover the droplets. Therefore we can assume that all the droplets in the capillary are covered with the particles at concentrations higher than 1 mg/mL. This explains the slower extraction rate for suspension samples and the slight difference observed in extraction rate for concentrations higher than 1 mg/mL in FIG. 10-c. However, for sufficiently long time (>30 min) of extraction, the signal intensities of the droplets eventually become independent of the particle concentration as shown in FIG. 10-d. When tested with particle concentration ranging from 3.125 to 25 mg/mL, the average fluorescence intensities of the droplets after extraction for more than 30 min were the same (FIG. 10-e). This demonstrates that within the tested range, the amount of particles do not affect the efficiency of extraction. As the blocking effect from solid particles does not change the partition coefficient, the concentration of the analyte in the droplet liquid in equilibrium with the suspension does not depend on the solid concentration. Therefore, after sufficiently long time, the analyte concentration in the droplets reached the same level, independent of the solid contents. Extraction may be influenced if the analytes and solid content in the sample interact with each other such as in the case of sorption of chemicals onto micro/nanoplastics via hydrophobic and electrostatic interactions.

Extraction Performance and Sensitivity of Nano-Extraction from Solid Suspension

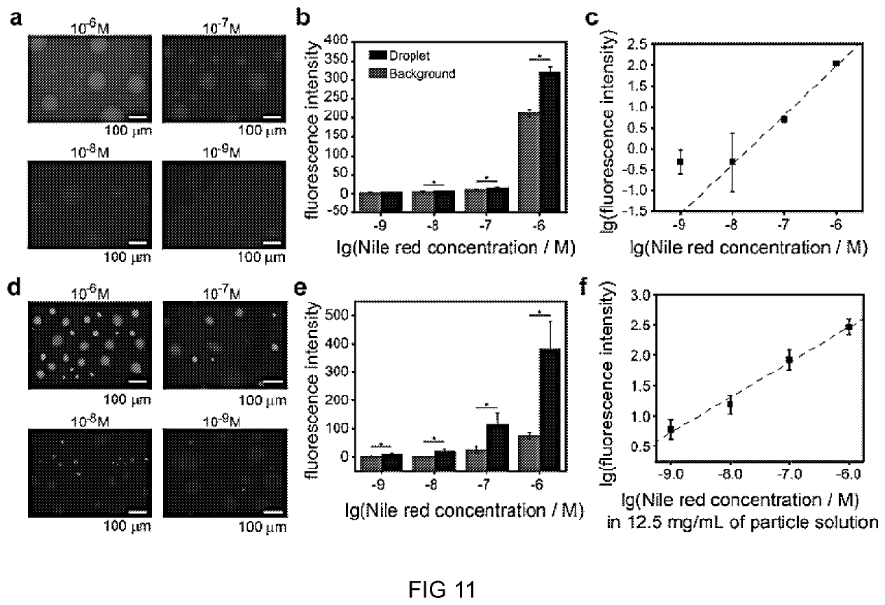

FIG. 11 illustrates limit of detection and low sample volume requirement of portable nano-extraction device. a) Fluorescent images of surface nanodroplets after extracting Nile red from water with different initial concentrations. b) Average fluorescence intensity values of surface nanodroplets and the background after extraction of Nile red from water. Here, * indicates p<0.05. c) Fluorescence intensity of droplets after subtracting the background signal. The slope in this log-log plot is ˜1.2. The outlier point indicates that the limit of detection for Nile red is 10⁻⁹ M. d) Fluorescent images of surface nanodroplets after extracting Nile red from silica solution (12.5 mg/mL) with different initial concentrations. e) Average fluorescence intensity values of surface nanodroplets and the background after extraction of Nile red from water. Here, * indicates p<0.05. f) Fluorescence intensity of droplets after subtracting the background signal. The slope of the log-log plot is ˜0.6.

FIG. 11-a shows the fluorescent images of octanol surface nanodroplets after extracting Nile red dyes from particle-free aqueous solution at initial concentrate range of 10⁻⁶ M to 10⁻⁹ M. Nile red has an octanol-water partition coefficient of lgP˜ 5 so the concentration of dye in octanol is ˜10000× that of water in equilibrium. As a result, after extraction, the droplets can clearly be differentiated from the background, owing to the higher concentration of the analyte.

Quantification of fluorescence intensities in droplets and background aqueous solution demonstrates that the limit of detection for Nile red dye from aqueous solution is 10⁻⁸ M. FIG. 11-b shows the average fluorescence intensity of the droplets and background aqueous solution measured in the vicinity of each corresponding droplet. The intensity in the droplet is higher for initial Nile red concentration range of 10⁻⁶ M to 10⁻⁸ M with statistical significance (p<0.05). However, at the dye concentration of 10⁻⁹ M, no difference between the droplets and background suspension was observed. Taking the logarithm of the difference between the average intensity values of droplets and of the background aqueous solution yields a calibration curve in log-log scale, correlating the fluorescence intensity and the initial dye concentration (FIG. 11-c), with a power law dependence with exponent ˜1.2 in the range of initial concentrations between 10⁻⁶ M to 10⁻⁸ M, which is the limit of detection.

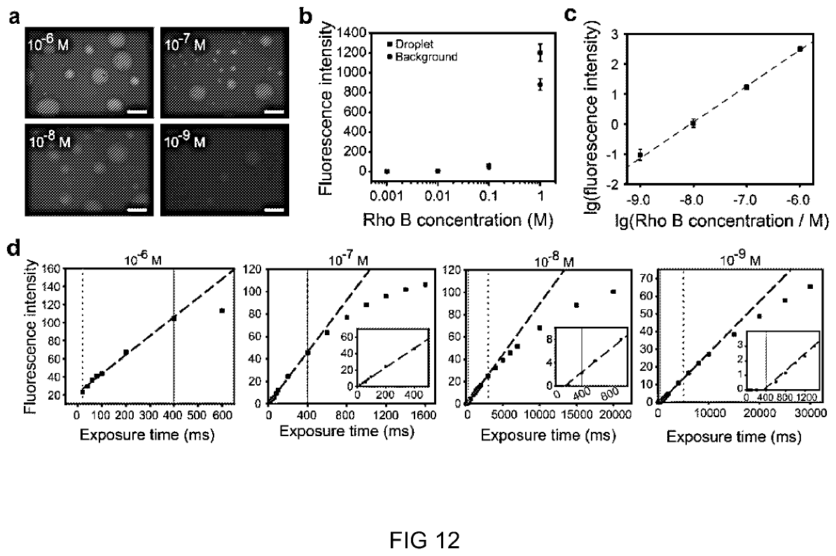

FIG. 12 illustrates limit of detection for Rhodamine B dye. a) Images of surface nanodroplets after extracting Nile red from different initial concentrations. For better visualization purposes, the brightness has been adjusted. b) Average fluorescence intensity values of surface nanodroplets as well as the background after nano-extraction for various initial concentration of Nile red. c) Fluorescence intensity of droplets after subtracting the background signal. The trend has a slope 1.2 when plotted in log-log scale. d) Background fluorescence intensities for Rhodamine B solution at various exposure times ranging 0 to 30 s. Vertical solid line indicates the exposure time to which the intensity data were normalized to (t=400 ms).

The limit of detection depends on factors such as the partition coefficient and the quantum efficiency of the fluorescent dyes. We compared to another model compound—Rhodamine B, which has a lower partition coefficient as compared to Nile red (lgP˜ 2.3 vs lgP˜ 5). With Rhodamine B, the limit of detection was lower (i.e. 10⁻⁹ M) as compared to Nile red (FIG. 12), possibly due to its comparatively higher quantum efficiency.

In the same way, the limit of detection for a suspension sample with 12.5 mg/mL of 150 nm silica particles was tested using Nile red as model compound. The initial concentration of Nile red in the silica solutions varied from 10⁻⁶ M to 10⁻⁹ M. FIG. 11-d shows fluorescent images of droplets after extraction of Nile red from the silica solutions. Again, the droplets can clearly be distinguished from the background suspension solution. The average fluorescence intensities of droplets are statistically higher compared to that of the background, down to initial Nile red concentration of 10⁻⁹ M, which is an order of magnitude lower than in the aqueous solution. The calibration curve in log-log scale obtained from the difference in droplet and background intensities reveals a power law, but with a lower exponent of ˜0.6. The lower limit of detection and lower power law exponent in the calibration curve may be due to the interaction of Nile red molecules at the particle-water interface.

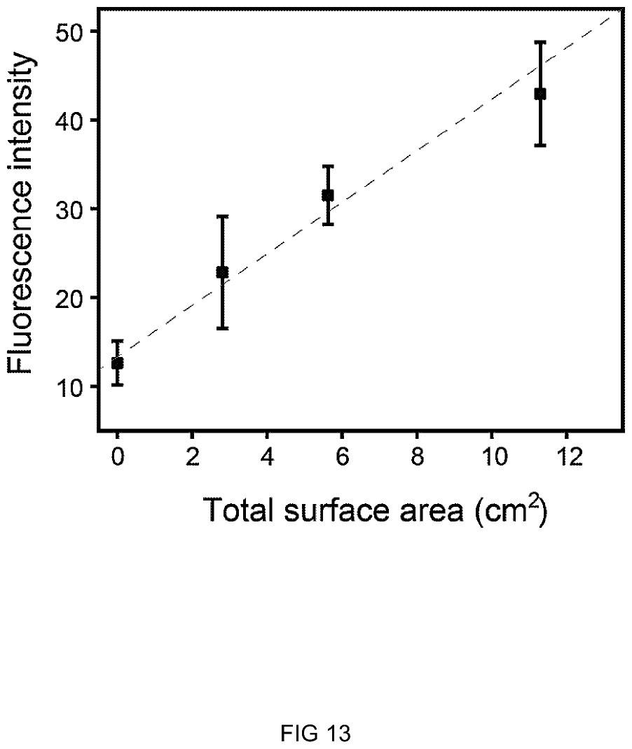

FIG. 13 illustrates a plot showing the relationship between the intensity of the droplet with the total surface area offered by the particles. The total surface area of the particles was calculated by multiplying the surface area of a 150 nm particle with the total number of the particles available in the capillary tube.

The advantageous high fluorescence intensity in the suspension samples compared to aqueous samples may be attributed to the adsorption and accumulation of the dye molecules at particle-liquid interfaces. FIG. 13 shows a plot of the fluorescence intensity of droplets and total surface area of particles corresponding to the concentration range between 3.125 mg/mL to 12.5 mg/mL. The total surface area of particles was calculated by multiplying the surface area of a single 150 nm particle (density ˜2 g/cm³) with the total number of particles available in the capillary tube (volume, 48 μL), which is determined by the particle concentration in suspension. At higher particle concentration, there is more area available for the analyte molecules to adsorb such that with more particles adsorbed at droplet-water interface, more analyte is available as well to increase the fluorescence signal.

### Influence of Sample Volume on Extraction Performance

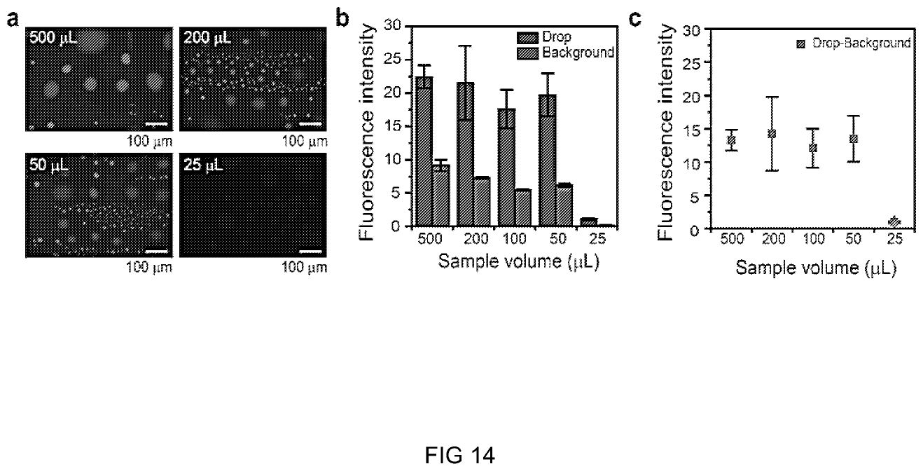

FIG. 14 illustrates processing of a sample at low volume. a) Fluorescence images of surface nanodroplets after extracting a 1 μM aqueous solution of Nile red at different sample volumes. For better visualization purposes, the brightness has been adjusted. b) Fluorescence intensity values of nanodroplets and background after extraction of 10⁻⁶ M Rhodamine B solution. c) Fluorescence intensity of droplets after subtracting the background signal. The intensity values for various sample volumes are similar from 500 μL to 50 μL, but the signal is negligible at sample volume of 25 μL.

Apart from simplicity and high efficiency, another advantageous feature of nano-extraction is small sample volume (on the order of μL), thanks to the confined geometry of the glass capillary. As shown in FIG. 14-a-b, detection of Nile red (concentration=10⁻⁶ M) can be performed with sample volumes as low as 50 μL. Fluorescence intensity of both the droplets and background remain unchanged down to 50 μL (FIG. 14-b). As a result, the difference between the signal from droplet and that from the background is also similar for the same range of sample volumes (FIG. 14-c), demonstrating reliable extraction.

The reason reliable extraction is observed with volume as low as 50 μL is attributed to the volume of the capillary, which is, 48 μL (i.d.=1.1 mm and length=50 mm). When the sample is introduced to the capillary, it can completely replace solution B and the droplets can extract the target analytes. On the other hand, for the case of 25 μL of volume, the sample does not thoroughly replace the solution contained in the droplet B such that the fluorescent intensity is very low when imaged with the same exposure time.

In addition, the fact that surface nanodroplets are on the scale of femtoliters can play a significant role in lowering the required sample volume. Liquid-liquid extraction relies on the partition coefficient (lgP) of the analytes which is determined by the concentration of the analytes in the sample and the extractant oil at equilibrium. Thus, even if the sample volume is low, the volumes of surface nanodroplets can still be much lower than that of the sample, enabling reliable extraction.

Extraction of analytes from a low sample volume can be of high interest in many diagnostic applications involving body fluids such as saliva or blood. However, in conventional extraction methods such as DLLME or single-drop microextraction, the volume of sample is usually increased by diluting the sample with water prior to extraction. In doing so, the concentration of analyte in the sample decreases, reducing the sensitivity. Moreover, many of the commonly used microextraction processes that employ centrifugation are challenged by the difficulty of separating the centrifuged oil pellet from the sample if the sample volume is low.

Extraction of Target Analyte from Oil Sand Wastewater

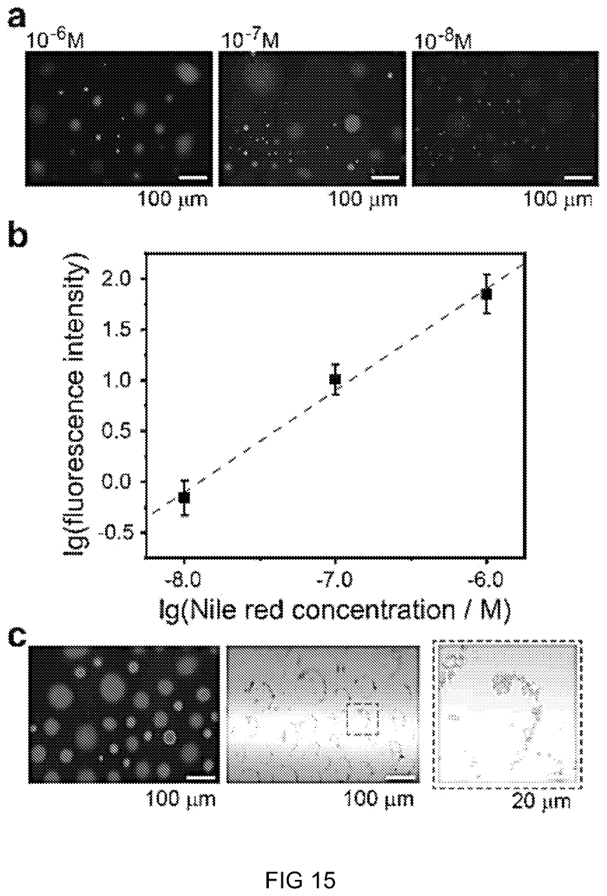

FIG. 15 illustrates extraction of analyte from complex oil sand wastewater sample. a) Fluorescence images of oil sand wastewater with Nile red at 10⁻⁶ M to 10⁻⁸ M. b) Limit of detection for Nile red in oil sand wastewater sample. When plotted in log-log scale, a linear trend is observed, i.e. the slope is ˜1. c) Extraction of 10⁻⁶ M Nile red dye from oil sand wastewater with high solid content (˜30 wt %). The dye is readily extracted into the droplets. However, presence of particle aggregates are observed at the droplet-water interface.

The portability of the entire device is potentially useful for analysis in the field such as in environmental monitoring. As a proof-of-concept demonstration, we show extraction of target analyte from oil sand wastewater comprising of solid particles, bitumen (heavy oil) and other hazardous hydrocarbons such as naphthenic acids or adamantane. Detection of such analytes from oil sand wastewater is important for the environment as seepage of these chemicals into the ground or surface waters can cause adverse effects to the aquatic life.

In FIG. 15-a we show extraction of Nile red from a oil sand wastewater sample comprising of 0.1 wt % bitumen, 7 wt % solids (fines and sands) and 92.9 wt % water. Prior to extraction, Nile red—mimicking hydrophobic compounds in the wastewater—was added to the oil sand wastewater sample at concentrations ranging from 10⁻⁶ M to 10⁻⁹ M. Similar to extraction from silica suspension, we determined the limit of detection for the oil sand wastewater sample based on fluorescence intensity in droplet and in background. The limit of detection was 10⁻⁸ M, an order of magnitude lower than that of silica solution as shown in FIG. 15-b. The lower detection sensitivity from oil sand wastewater may be attributed to the sorption of Nile red molecules to the solid particles that are potentially fouled by bitumen. As bitumen is known to be an aggressive foulant, it is possible for solid particles to have bitumen coating on the surface. Then Nile red can be adsorbed on the bitumen-coated solids lowering, the liquid-liquid extraction efficiency by the surface nanodroplets.

Nonetheless, extraction was successful even with oil sand wastewater sample with a higher solid content of, 30 wt % as shown in FIG. 15-c. The sample was spiked with 10⁻⁶ M of Nile red dye and it was injected to the capillary device after forming surface nanodroplets with octanol. Nile red dye was readily extracted into the droplets from which strong fluorescence signal was detectable. Although some particles aggregated at the droplet-water interface due to their excessive amount in the sample, their influence would be minimal on the detection of extracted analytes in the droplets by in-situ methods.

### CONCLUSION

In summary, we demonstrated nano-extraction of model compounds from highly concentrated solid suspensions using surface nanodroplets formed via solvent exchange. Extraction of model analytes was achieved from suspension samples with solid content of up to 30 wt % without prior removal of solids. As a proof-of-concept, a target compound was extracted from an oil-sand slurry. A similar limit of detection was observed for both aqueous samples and suspension samples (10⁻⁸ M, 10⁻⁹ M), demonstrating that particles do not reduce the extraction efficiency of the target analytes. Instead, the particles initially slowed down the extraction rate due to their adsorption to the droplets. Thanks to the low volume of the capillary tube, extraction from the samples was possible with volume as low as 50 μL.

### Further Embodiments

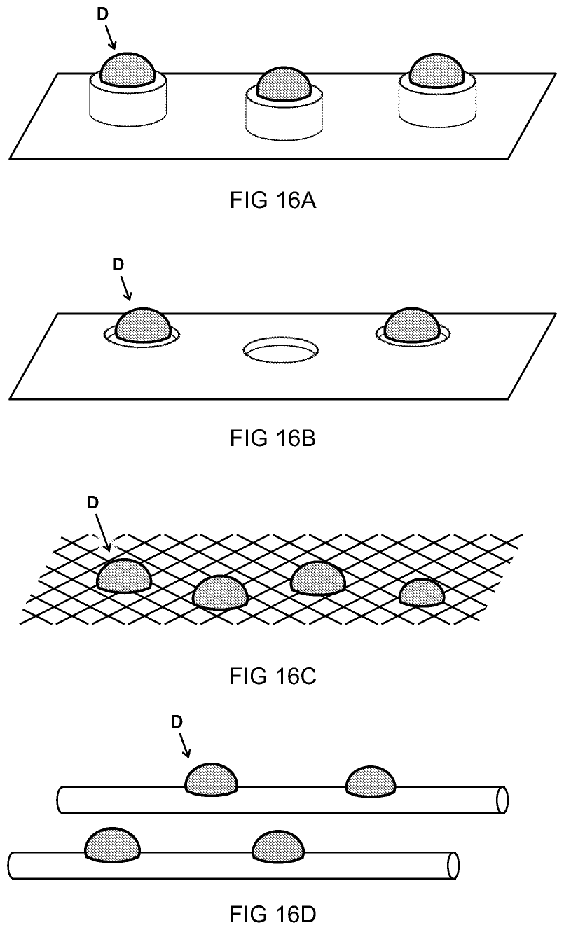

For the purpose of clarity and a concise description, features are described herein as part of the same or separate embodiments, however, it will be appreciated that the scope of the invention may include embodiments having combinations of all or some of the features described. Of course, it is to be appreciated that any one of the above embodiments or processes may be combined with one or more other embodiments or processes to provide even further improvements in finding and matching designs and advantages. For example, FIGS. 16A-D illustrates various geometries which can be applied to or used instead of the container wall for holding the liquid droplets D, as described herein. In one embodiment, e.g. as shown in FIG. 16A, the liquid droplets D are provided on a wall comprising respective protrusions or bumps. In another or further embodiment, e.g. as shown in FIG. 16B, the liquid droplets D are provided on a wall comprising respective recessions or indentations. In another or further embodiment, e.g. as shown in FIG. 16C, the liquid droplets D are provided on a mesh, e.g. grid of wires. In another or further embodiment, e.g. as shown in FIG. 16D, the liquid droplets D are provided onto one or more fibers. Advantageously, the size of the geometric features can be adapted, e.g. to control a size, location, and/or distribution of the liquid droplets. The geometric features can also be used to affect adhesive properties. Also combinations of these and other geometric features can be envisaged.

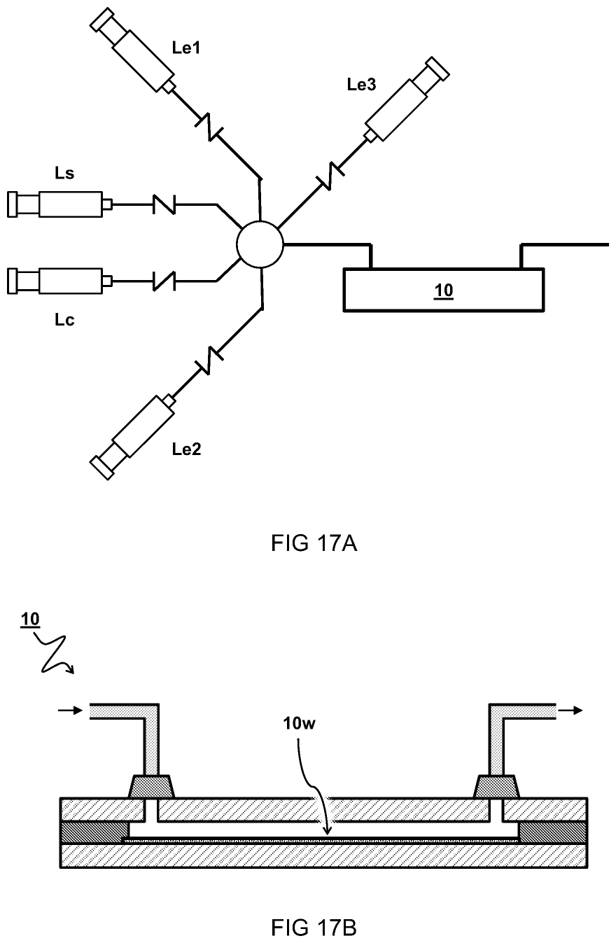

It is appreciated that this disclosure offers particular advantages to the analysis of small quantities of sample liquid, and in general can be applied for any application wherein at least one analytes is concentrated. The present methods and systems can also be used to concentrate multiple analytes, e.g. consecutively or simultaneously. In some embodiments, the droplets are formed by a mixture of two, three, or more different types of oil or other extractant. For example, more than one type of analyte can be extracted by providing droplets having respective, e.g. different, types components. In this way liquid droplets can be binary or ternary droplets (or even more components). In some embodiments, e.g. as illustrated in FIG. 17A, the droplet formation is automated, e.g. by connecting a set of different flow devices with respective valves to a flow distributor which can be connected to the container 10, e.g. flow cell or flow chamber as illustrated in FIG. 17B. In one embodiment, the components of the droplets are adjusted by controlling the flow rate of respective solutions Le1,Le2,Le3. Advantageously, the automated formation process can enable fast data collection to determine optimal solvent compositions for extraction. For example, the data can be used as the data bank for machine learning and AI.

In interpreting the appended claims, it should be understood that the word “comprising” does not exclude the presence of other elements or acts than those listed in a given claim; the word “a” or “an” preceding an element does not exclude the presence of a plurality of such elements; any reference signs in the claims do not limit their scope; several “means” may be represented by the same or different item(s) or implemented structure or function; any of the disclosed devices or portions thereof may be combined together or separated into further portions unless specifically stated otherwise. Where one claim refers to another claim, this may indicate synergetic advantage achieved by the combination of their respective features. But the mere fact that certain measures are recited in mutually different claims does not indicate that a combination of these measures cannot also be used to advantage. The present embodiments may thus include all working combinations of the claims wherein each claim can in principle refer to any preceding claim unless clearly excluded by context.

1. A method for concentrating an analyte, the method comprising
providing a wall of a container with liquid droplets of an extractant liquid adhered to the wall;
providing a sample fluid comprising the analyte in the container to contact the liquid droplets, wherein the analyte has a higher solubility in the liquid droplets than in the sample fluid causing the analyte to be extracted from the sample fluid and concentrated in the liquid droplets; and
collecting the liquid droplets from the wall for obtaining the concentrated analyte.

2. The method according to claim 1, wherein the liquid droplets are collected by mechanically scraping the liquid droplets from the wall.

3. The method according to claim 1, wherein the liquid droplets are adhered to an inside wall of a fluid duct forming the container, and the liquid droplets are collected from the inside wall by pushing a tool through the fluid duct.

4. The method according to claim 1, wherein, prior to collecting the liquid droplets from the wall, the sample fluid is removed from the container.

5. The method according to claim 4, wherein the sample fluid is removed from the container by a flow of a cleaning liquid, wherein the cleaning liquid is removed by drying.

6. The method according to claim 1, wherein the sample fluid comprises a sample liquid dissolving or otherwise carrying the analyte, wherein the extractant liquid and sample liquid are essentially immiscible.

7. The method according to claim 1, wherein the sample liquid is formed by a slurry having a solid content of at least ten weight percent.

8. The method according to claim 1, wherein the liquid droplets are adhered to an inside wall of a fluid duct forming the container, wherein providing the sample fluid in the container to contact the liquid droplets comprises flowing a sample liquid dissolving or otherwise carrying the analyte through the container while the liquid droplets stay adhered to the wall.

9. The method according to claim 1, wherein the container is formed by a capillary tube, wherein the liquid droplets are surface nanodroplets having a height less than hundred nanometer and/or a volume less than ten femtoliter.

10. The method according to claim 1, wherein the analyte is concentrated from a sample liquid having a total volume of less than one milliliter.

11. The method according to claim 1, wherein the liquid droplets are removed from the wall and combined to form a concentrated liquid in a second container.

12. The method according to claim 1, wherein the method further comprises measuring the analyte in a concentrated liquid formed by collecting the liquid droplets from the wall.

13. A system for concentrating an analyte, the system comprising
a capillary tube having a hydrophobized inner wall;
a flow controller coupled to the capillary tube and programmed to subsequently
provide a flow of an extractant liquid through the capillary tube, wherein the extractant liquid has a first adhesiveness to form liquid droplets of the extractant liquid adhered to the inner wall,
provide a flow of the sample liquid with the analyte through the capillary tube to contact the liquid droplets, wherein the analyte has a higher solubility in the liquid droplets than in the sample liquid causing the analyte to be extracted from the sample liquid and concentrated in the liquid droplets; and
remove the sample fluid from the capillary tube, leaving the liquid droplets; and
a tool configured to automatically collect the liquid droplets from the inner wall for obtaining the concentrated analyte.

14. The system according to claim 13, wherein the system further comprises one or more of
a supply of cleaning liquid coupled with the capillary tube via the flow controller, wherein the flow controller is configured to provide a flow of the cleaning liquid through the capillary tube for flushing the sample liquid; and
a dryer or centrifuge coupled with the capillary tube, and configured to remove the sample liquid and/or cleaning liquid prior to the tool automatically collecting the liquid droplets.

15. The system according to claim 13, wherein the system further comprises an analyzer configured to receive a concentrated liquid formed of the collected liquid droplets with the concentrated analyte, wherein the analyzer is configured to measure the analyte in the concentrated liquid.
